(19) United States
(12) Patent Application Publication
(10) Pub. No.: US 2011/0195373 A1
(43) Pub. Date: Aug. 11, 2011

(54) Template for Selecting Orthodontic Arch Wires and Method of Placement

(76) Inventor: Robert L. Waugh, Athens, GA (US)

(21) Appl. No.: 13/016,094

(22) Filed: Jan. 28, 2011

Related U.S. Application Data
(60) Provisional application No. 61/300,947, filed on Feb. 3, 2010.

(51) Int. Cl. A61C 7/02

(52) U.S. Cl. 433/24; 433/3

(57) ABSTRACT

A dental arch template includes a transparent fitting plate having a perimeter shaped to fit inside the human mouth of a patient with the fitting plate being Y-shaped with a stem and a pair of spaced side legs extending away from said stem, and at least one image of an arch wire formed in a U-shape that generally conforms to the dental arch of a human imposed on said pair of spaced side legs of said transparent fitting plate.

### CROSS REFERENCE

Applicant claims the benefit of Provisional Patent Application Ser. No. 61/300,947, filed in the U.S. Patent & Trademark Office on Feb. 3, 2010.

### FIELD OF THE INVENTION

This invention concerns orthodontic wires, known as arch wires, that are employed as a force transmitting device that adjust the positions of teeth of the human mouth, and to templates for matching properly sized orthodontic arch wires to a dental arch of a patient

### BACKGROUND OF THE INVENTION

Orthodontists use wires and brackets for straightening teeth, with the individual brackets each attached to a tooth of an upper or lower dental arch of a patient and a the wire placed exteriorly of and surrounding the upper or lower dental arch of the patient and connected to the brackets. The wire applies forces to the teeth and adjusts the position and orientation of the teeth.

The present day orthodontic wires are pre-formed in a U-shape by the manufacturer so that when they are received by the orthodontist they are in a predetermined arch shape and dimension and are referred to as “arch wires”. The arch wires usually are either round or rectangular in cross-sectional shape. The arch wires are made of metals such as stainless steel, titanium, nickel, copper, and other types of materials, both individually and in various combinations. Some are resilient so that the wire may be selectively bent to fit the dental arch but retain the resiliency to apply forces to the individual teeth of a dental arch; others may not be deformed by the orthodontist at all. The brackets are used to transmit force from the arch wire to the teeth that must be repositioned, moving the teeth inward, outward, upward, downward, and, in some cases, even rotating the teeth to face different directions. The teeth may also be selectively ‘torqued’ whereby their roots and/or crowns are tipped slightly inwardly or outwardly.

The orthodontist may form small bends in some arch wires to influence the shape of the patient's dental arch, and with the corresponding position and orientation of select teeth in the dental arch affected so that each bracket more favorably applies the desired force to such teeth.

The resilience of the deformed arch wire is transmitted to each tooth in the dental arch, and through the teeth to the structures supporting the teeth in their sockets, to move the teeth into positions in better alignment with other teeth along the arch, for example. As the alignment occurs, the arch wire's effect is relaxed and becomes more passive, but maintains the aligned teeth in their desired position.

Some orthodontists tend to use a system that prescribes a single size and shape arch wire for substantially all patients, even for patients having dental arches that are considerably larger or smaller than an average size dental arch and/or teeth that are considerably larger or smaller than average. The single size arch wire may be suitable for a set group of the patients receiving braces, but in many other patient situations the dental arches of the patients are much larger or much smaller than the one size arch wire allows. This requires the orthodontist to radically adjust the shape of the arch wire to fit the patient's dental arch or to select a larger or smaller arch wire, if available.

It is desirable to have arch wires available to orthodontists that more perfectly create the final shape of the dental arches of the patients to be treated. The use of an appropriately sized arch wire tends to avoid extra effort by the orthodontist and provides an arch wire that is more comfortable for the patient and more readily fits the needs of the patient. This avoids excess force applied to the teeth and supporting structures of a patient when the arch wire does not appropriately fit the specific dimensions of the patient's arches.

Multiple size arch wires are not generally available in systems that rely on a single sized wire, but even when different arch wires are available, the orthodontist or the assistant to the orthodontist may not be readily able to accurately measure the dental arch of a patient and to accurately match the proper sized arch wire to the patient.

As disclosed in U.S. Pat. No. 6,736,637, permanent markings may be made on an arch wire when the arch wire is manufactured. The markings of the arch wire usually designate the positions of certain ones of the teeth of the typical human dental arch, and the markings may be used by the orthodontist to locate the positions of bends that are necessary for the arch wire when the arch wire is matched with the teeth of the dental arch of the patient. The markings on the arch wire may be made by etching, engraving, indentation, or other permanent types of marks made in or on the metal of the arch wire. The markings may be made in one surface of the rectangular cross sectional shape of the arch wire that face the orthodontist when treating the patient. Since the orthodontist is likely to adjust the bends of an arch wire after the arch wire has been fitted to the patient, it is important for the markings on the arch wire to be substantially permanent and visible to the orthodontist. The permanent pre-marking of arch wires tends to eliminate problems such as fading of the marks over time while the arch wire is placed in the patient and, therefore, loss of orientation of bends, etc. in the arch wire.

The permanent pre-markings allow the later adjustment of the arch wire with respect to the brackets so that upon subsequent adjustments of the brackets and arch wires, the orientation will not be lost.

This disclosure concerns improvements in the process of placing the correct size arch wires in patients and the devices used for accurately matching the different size arch wires to the dental arches of patients.

### SUMMARY OF THE DISCLOSURE

Briefly described, this disclosure concerns a template for matching properly sized orthodontic arch wires to a dental arch of a patient, including a fitting plate having a perimeter shaped to fit inside the human mouth and in juxtaposition with a dental arch of the patient, and at least one image or shape of an arch wire imposed on the fitting plate that generally conforms to the dental arch of a human.

The template may be transparent for viewing the teeth and the braces of the patient through the fitting plate and may include marks for the positions of teeth and a scale imposed adjacent the image of the arch wire.

The template may include several images of arch wires on the fitting plate with the images arranged concentrically in a nested configuration and in graduated sizes.

The fitting plate may include images of three arch wires arranged in nested configuration in graduated sizes, with the images of the arch wires being substantially U-shaped with a curved intermediate leg and curved side legs having substantially parallel end portions extending from the intermediate leg, with the fitting plate being substantially Y-shaped, and with the open ends of the U-shaped images of the arch wires oriented toward the top of the “Y” shape.

The Y-shaped fitting plate may include spaced side legs (top of the “Y”) on which the curved side legs of the U-shaped arch wire image extend and a stem (bottom of the “Y”) for extending away from the curved intermediate leg of the U-shaped image of the arch wires. Such a stem serves as a handle for the orthodontist or assistant to grasp the fitting plate during use.

The fitting plate may include markings where the markings of a correctly sized arch wire are located so as to match the markings of the arch wire to the dental arch.

The disclosure also concerns a method of measuring the dental arch of the human mouth by placing the pair of spaced side legs of the transparent fitting plate in alignment with the adjacent dental arch of the human mouth and viewing the teeth of the human mouth through the transparent fitting plate, and comparing the dental arch with the images of the three dental arch wires imposed on the fitting plate.

These and other features, objects and advantages of the invention will become apparent upon reading the following specification, when taken in conjunction with the accompanying drawings

### BRIEF DESCRIPTION OF THE DRAWINGS

FIG. 1 is a plan view of the dental arch template with images of arch wires and measuring scales applied to it.

FIG. 2 is a plan view of a similar dental arch template without a scale applied to it.

FIG. 3 is a perspective view of the dental arch template as it is being applied to the dental arch of a patient by an orthodontist or an assistant.

FIG. 4 is a plan view of the dental arch template, similar to FIG. 1 but showing the template as it is applied to the lower teeth of a patient.

FIG. 5 is a front, expanded view of arch wires and brackets applied to teeth.

### DETAILED DESCRIPTION

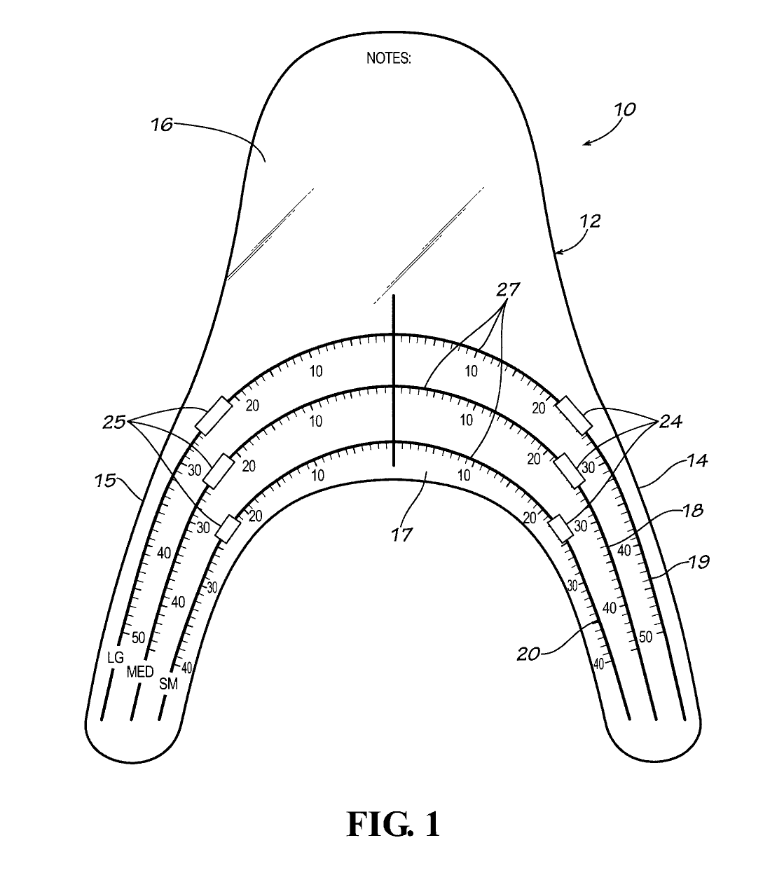

Referring now in more detail to the drawings in which like numerals indicate like parts throughout the several views, FIG. 1 shows the dental template 10 that includes a fitting plate 12 that may be formed of transparent plastic material, such as acrylic or polycarbonate, which is semi-rigid so that it tends to retain its original shape, but can be bent under appropriate force as needed. The term “transparent” is intended to include various degrees of transparency, from translucent to perfectly clear. The fitting plate may have portions that are not transparent but have visual indications of arch wires, any markings that may appear on arch wires, and other indications that may be used for selecting the proper sized arch wire for the patient. Also, the fitting plate may be made of material that can be marked with a pen so that the orthodontist may apply removable information on the fitting plate, such as marking a position where a bend is to be located on the arch wire for that patient at that appointment.

The fitting plate has a perimeter that may be substantially Y-shaped having spaced side legs 14 and 15 to fit inside the human mouth over and along the sides of the dental arch of a patient, that diverge from a stem 16 that is joined to the base 17 of the side legs 14 and 15. The stem 16 is to extend out of the mouth of the patient and to be used by the orthodontist or the assistant to hold and manipulate the fitting plate. The shape of the side legs generally conforms to the shape of a dental arch, so that the side legs 14 and 15 and base 17 may be inserted into the mouth of the patient for placement over and in juxtaposed alignment with the teeth on each side of the patient's arch, with the dental assistant or the orthodontist manipulating the dental template by holding the stem 16 which protrudes from the mouth of the patient.

The arch formed by the side legs 14 and 15 and base 17 of the fitting plate generally correspond to the shape of an arch wire to be placed adjacent the teeth of the patient for the purpose of attaching brackets between the arch wire and the surfaces of the teeth of the patient.

At least one image of an arch wire 18 may be carried by the diverging base 17 and side legs 14 and 15 of the fitting plate 12. Also, several, such as three, images of arch wires 18, 19 and 20 may be imposed on the side legs 14 and 15 and on base leg 17. The images of the arch wires 18-20 of FIG. 1 may be of medium, large and small arch wires, having the images of the arch wires “nested” concentrically within one another and spaced apart an appropriate distance according to the progressive sizes of the arch wires.

The images of the arch wires may be imposed on either surface of the fitting plate, or may be imbedded interiorly of the material that formed the fitting plate so that the images are permanent and do not disappear or become obliterated by use of the dental arch template. The images of the arch wires may be of different colors with respect to one another to indicate different size arch wires.

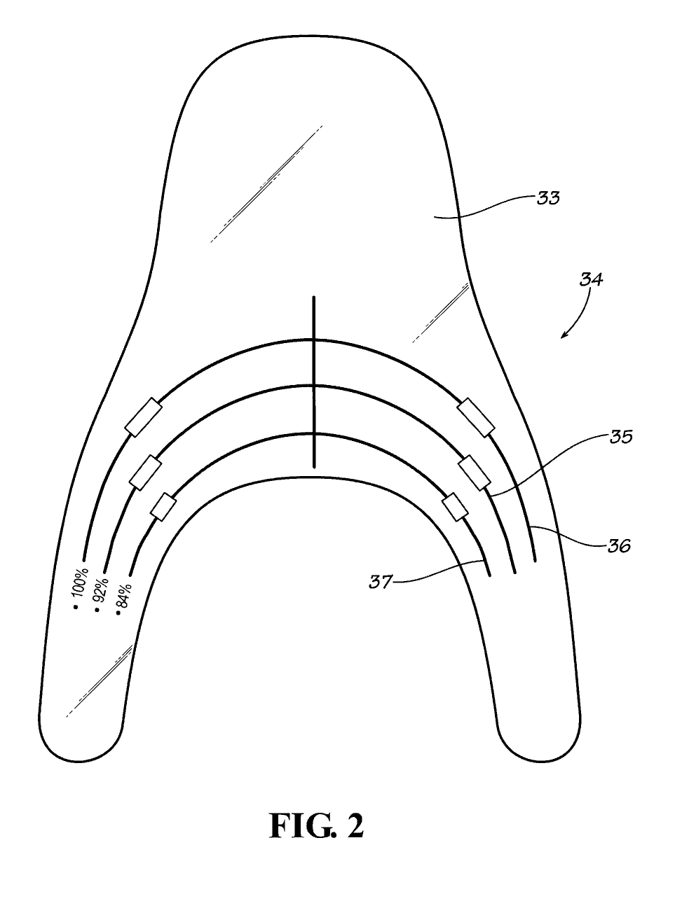

FIG. 2 illustrates a similar dental arch template 34 that does not have a numerical scale imposed on the fitting plate 33 but includes images of dental arches of three sizes, 35, 36 and 37. The relative sizes of the arch images may be indicated by percent of the largest of the three arch images, such as 100%, 92% and 84%, or by other means such as diameter of the arches or by color of each arch image

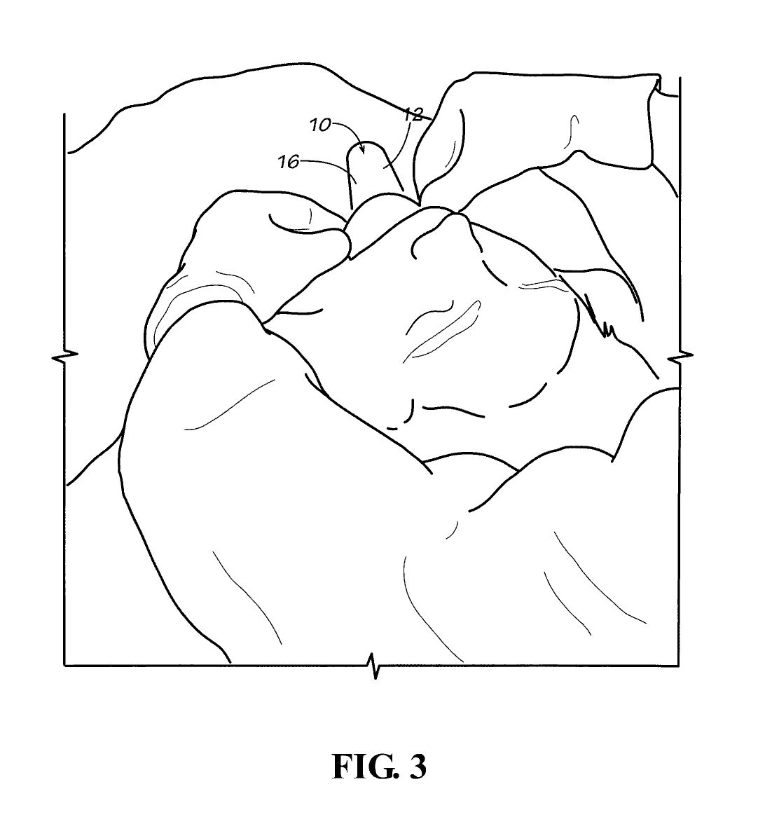

As shown in FIG. 3, the stem 16 of the fitting plate 12 of the dental template 10 may be used by the orthodontist or the assistant as a handle with which to manipulate the dental template when inserting it into the mouth of the patient, and particularly when placing the images of the arch wires 18-20 over the existing wire in place on the brackets attached to the teeth of the patient's lower dental arch.

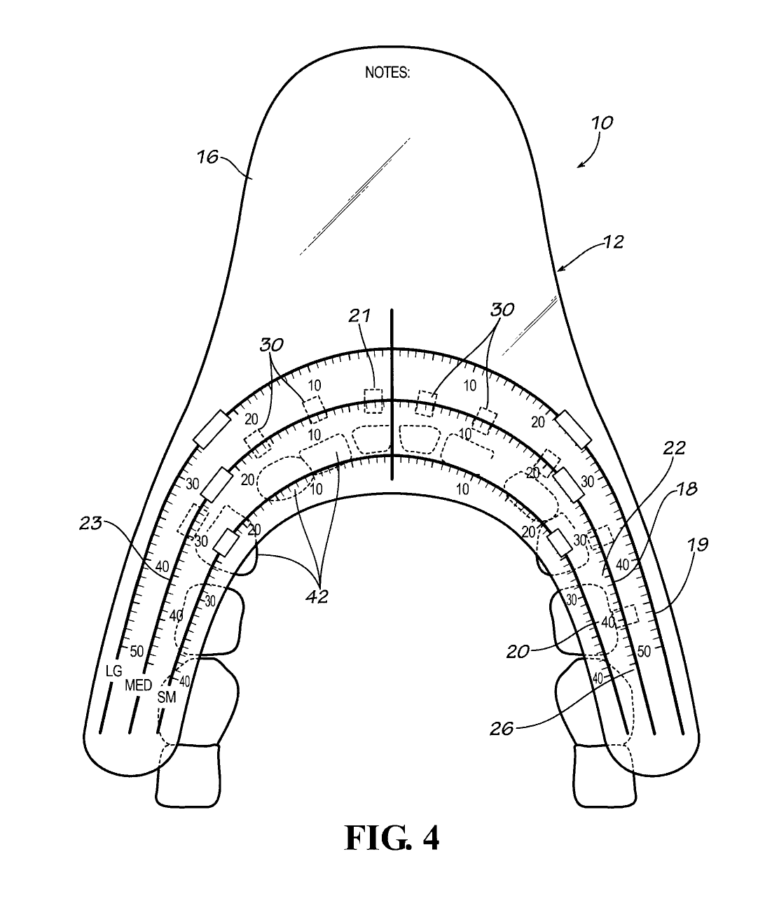

For example, the orthodontist may place the fitting plate 12 over the lower arch, as shown in FIG. 4, with the curved intermediate leg 21 over the front teeth so that the curved side legs 22 and 23 tend to become aligned with the back teeth of the dental arch. This aligns the center U-shaped image of the three arch images over the existing wire in place and thereby easily identifies the wire in place as a large, medium, or small wire, thus enabling the orthodontist to select the correct wire size (large, medium, or small) moving forward in the patient's treatment.

A similar process may be performed with the upper teeth of the patient. Typically, the upper dental arch will be larger than the lower dental arch and a different dental template may be required for the upper teeth that have larger images of arch wires imposed upon it.

As shown in FIG. 1, the template 10 may also include markings of teeth positions along the images of the arches on the fitting plate 12 so that the orthodontist or assistant may make marks on the fitting plate where the bends in the arch wire are to be located. For example, FIG. 1 shows teeth positions 24 and 25 printed on each of the legs 14 and 15 for indicating the typical positions of the eye teeth.

As shown in FIG. 1, a scale 27 may be printed along each arch image 18-20 of the fitting plate 12 of the arch wire template. FIG. 2 shows that other information may applied to the fitting plate. The material of the fitting plate may receive pen markings for notes to be made by the orthodontist adjacent the scale 27. The identification of the patient and other useful information may be marked on the fitting plate.

FIG. 4 discloses the dental template 10 of FIG. 1, but shows how the image of the arch wires 18-20 will register with the existing arch wire in place within the braces placed on the teeth of the lower dental arch 26 of the patient. In this instance, as shown in FIG. 4, it appears that the intermediate size image of an arch wire 20 may be the most appropriate size for the dental arch.

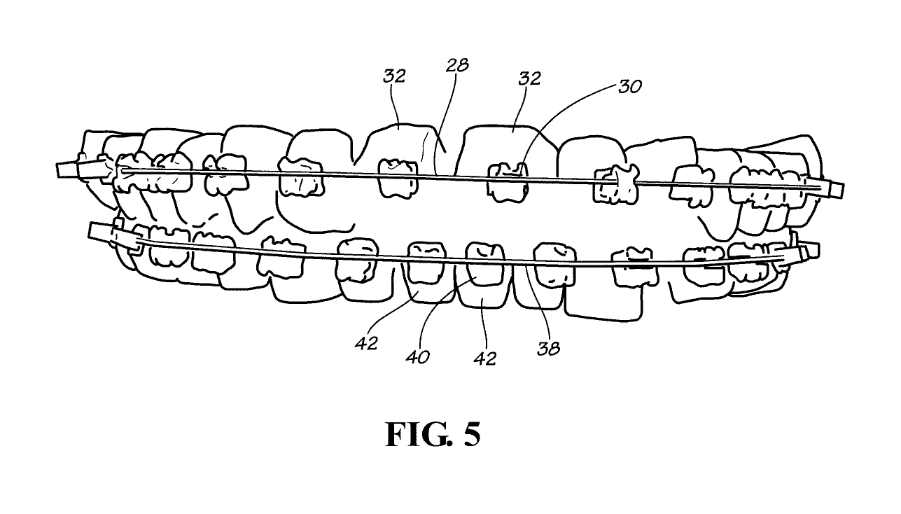

FIG. 5 generally shows the configuration of the arch wire 28 that is spaced in front of the upper teeth of the patient, with brackets 30 connected between the arch wire and teeth 32. Likewise, the lower arch wire 38 is shown attached by brackets 40 to the lower teeth 42.

Although a preferred embodiment of the invention has been disclosed in detail herein, it will be obvious to those skilled in the art that variations and modifications of the disclosed embodiment can be made without departing from the spirit and scope of the invention as set forth in the following claims.

1. A template for fitting orthodontic arch wires to a dental arch of a patient, comprising
a fitting plate having a perimeter shaped to fit inside the human mouth of a patient, and
at least one image of an arch wire formed in a U-shape that generally conforms to the dental arch of a human imposed on the fitting plate.

2. The template of claim 1, wherein the template is transparent for viewing the teeth and braces and arch wires of the patient through the template.

3. The template of claim 2, wherein said at least one image of an arch wire comprises several images of arch wires arranged in nested configuration in determined graduated sizes.

4. The template of claim 3, wherein said at least one image of an arch wire comprises images of three arch wires arranged in nested configuration in determined graduated sizes.

5. The template of claim 1 wherein
said image of an arch wire is substantially U-shaped with a curved intermediate leg and curved side legs having substantially parallel end portions extending from said curved intermediate leg,
said fitting plate is substantially Y-shaped and includes spaced side legs on which said curved side legs of said arch wire image are imposed, and
a stem for extending away from said curved intermediate leg of said image of an arch wire and acting as a handle that extends from the mouth of a patient.

6. A template for fitting orthodontic arch wires to a dental arch of a patient, comprising
a transparent fitting plate having a perimeter shaped to fit inside the human mouth of a patient,
said fitting plate being Y-shaped with a stem and a pair of spaced side legs extending away from said stem,
at least one image of an arch wire formed in a U-shape that generally conforms to the dental arch of a human imposed on said pair of spaced side legs of said transparent fitting plate.

7. The template of claim 6, wherein a scale is positioned adjacent said at least one image of an arch wire and configured for indicating positions of teeth.

8. The template of claim 6, wherein said transparent fitting plate is made of a material on which markings may be made by a pen.

9. The template of claim 6, wherein teeth positions are permanently printed on said template.

10. The template of claim 6, wherein said images of arch wires on said template are of different colors that correspond to different size arch wires.

11. A method of measuring the dental arch of the human mouth by placing the pair of spaced side legs of the transparent fitting plate of claim 6 in alignment with and adjacent to the dental arch of the human mouth and viewing the teeth and braces and wires of the human mouth through the transparent plate and comparing the arch wire in place with the corresponding image of a dental arch wire imposed on the measuring plate.
